(19) United States
(12) Patent Application Publication
(10) Pub. No.: US 2002/0042707 A1
(43) Pub. Date: Apr. 11, 2002

(54) Grammar-packaged parsing

(76) Inventors: Gang Zhao, Bruxelles (BE); Luc Van Tichelen, Waregem (BE)

Correspondence Address: BROMBERG & SUNSTEIN LLP, 125 SUMMER STREET, BOSTON, MA, 02110-1618, US

(21) Appl. No.: 09/883,858

(22) Filed: Jun. 18, 2001

Related U.S. Application Data
(60) Provisional application No. 60/212,263, filed on Jun. 19, 2000.

(51) Int. Cl. G06F 17/27

(52) U.S. Cl. 704/9

(57) ABSTRACT

A method of parsing a stream of tokens representative of language usage is provided in one embodiment. The method includes:

a. storing a set of packages, each package being representative of a phrase-structure tree, each tree derived from a rule-based grammar; and

b. parsing the stream using the packages to establish a structural description for the stream.

In another embodiment, there is also provided a method of parsing a stream of tokens representative of language usage. The method of this embodiment includes:

a. storing a set of packages, each package being representative of a phrase structure tree associated with a grammar, wherein a subset of the packages includes a set of relational descriptions, and

b. parsing the stream using the packages establish a structural description and a relational description of the stream.

This application claims priority from provisional application Ser. No. 60/212,263, filed Jun. 19, 2000, for an invention of the same inventors as herein, entitled “Grammar-Package Parsing”; such related application is hereby incorporated herein by reference.

### TECHNICAL FIELD

The present invention relates to syntactic parsers and their components for use in digital computers.

### BACKGROUND ART

Syntactic parsers, driven by a set of syntactic rules, analyze sentences into syntactic structures called phrase structure trees. It is known in the prior art of corpus-based parsers to employ phrase structure trees and their statistics. The trees used for parsing in this approach are derived from a manually annotated corpus of sentences. If the corpus is representative of linguistic usage such an approach helps to assure a relatively thorough set of trees for purposes of parsing. On the other hand, there is a substantial computational overhead associated with this approach due to the substantial complexity of language analyzed in this fashion.

References concerning grammatical parsers and related subject matter include the following, which are hereby incorporated herein by reference in their entirety:

Abney, S., Partial parsing viafinite-sate cascades, ESSLLI'96 Robust Parsing Workshop, 1996

Aho, A. V. and J. D. Ullman, The Theory Of Parsing, Translation And Compiling, Prentice Hall, 1972.

Aho, A.V., R. Sethi and J. D. Ullman, Compilers: Principles, Techniques And Tools, Reading MA: Addison-Wesley, 1986.

Bod, R. and R. Scha, Data-Oriented Language Processing: An Overview, Institute for Logic, Language and Computation, University of Amsterdam, 1996.

Bolc, L, Natural Language Parsing Systems, Springer-Verlag, 1987, Heidelberg.

Briscoe, J. and J. Carroll, Generalized Probabilistic LR Parsing of Natural Language with Unification-based Grammar, Computational Linguistics, 1993, vol 19, no 1, pages 25-59.

Charniak, E., Tree-bank Grammars, CS-96-02, Brown University, 1996.

Charniak, E. Statistical techniques for natural language parsing, Al Magazine, 1997.

Chelba, C. et al., Structure and performance of a dependency language model, Proceedings of Eurospeech'97, 1997.

Chomsky, N., Lectures on Government and Binding, Foris, 1981.

Chomsky, N., Three Models For Description Of Language, in IRE Transactions PGIT, 2 113-114, 1956.

Collins, M. J., A New Statistical Parser Based On Bigram Lexical Dependencies, in IRE Transactions PGIT 1956.

Covington, M. A., A Dependency Parser For Variable-Word-Order Languages, Artificial Intelligence Programs, University of Georgia, 1990.

Earley, J. An Efficient Context-Free Parsing Algorithm, In Processing in Grosz, B., K. Jones and B. Webber ed. Readings in Natural Language Processing, Morgan Kaufmann, 1986.

Fraser, N. M., Parsing and Dependency Grammar, UCL Working Papers in Linguistics 1, 1989.

Hayes, D. C., Dependency Theory: A Formalism And Some Observations, Language, 1964, 40, 511-525.

Hudson, R., English Word Grammar, Blackwell, 1990, Oxford.

Kaplan, R. M., The Formal Architecture Of Lexical-Functional Grammar, Journal of Information Science and Engineering, 1989, 5, 305-322.

Kaplan, R. and J. Bresnan, Lexical-Functional Grammar: A Formal System For Grammatical Representation, 173-281, The Mental Representation of Grammatical Relations, MIT.

Kay, M., Algorithm Schemata And Data Structures In Syntactic Processing in Grosz, B., K. Jones and B. Webber ed. Readings in Natural Language Processing, Morgan Kaufmann, 1986.

Lafferty, I et al., Grammatical trigrams: a probabilistic model of link grammar, AAAI Fall Symposium on Probabilistic Approaches to Natural Language, 1992.

Magerman, D. M., Natural Language Parsing As Statistical Pattern Recognition, Department of Computer Science, 1986.

Marcus et al., Building a large annotated corpus of English: the Penn Treebank, Computational Linguistics, Vol. 19, 1993.

McCord, M. C., A New Version Of Slot Grammar, IBM Research Report RC 14506, IBM Thomas J. Watson Research Centre, 1989

Melcuk, I. A., Dependency Syntax: Theory And Practice, State University Press of New York, 1988.

Tesniere, L., Elements De Syntaxe Structurale, Klincksieck, 1959.

Tornita, M., Linguistic Sentences And Real Sentences, Proceedings of COLING, 1988.

Tomita, M., Efficient Parsing For Natural Language, Kluwer, 1986

Tomita, M. Current Issues in Parsing Technology, Kluwer, 1991, Boston.

One difficulty of parsing large word-count phrases or sentences using a context free grammar is that as the length of the sentence increases, the number of possible parses increases dramatically. Because parsing must, by one means or another, take into account these possible parses, the computational effort in parsing typically increases exponentially as the input to the parser increases in word count.

### SUMMARY OF THE INVENTION

In one embodiment of the invention, there is provided a method of parsing a stream of tokens representative of language usage. The method of this embodiment includes:

a. storing a set of packages, each package being representative of a phrase-structure tree, each tree derived from a rule-based grammar; and

b. parsing the stream using the packages to establish a structural description for the stream.

In another embodiment of the invention, there is also provided a method of parsing a stream of tokens representative of language usage. The method of this embodiment includes:

a. storing a set of packages, each package being representative of a phrase structure tree associated with a grammar, wherein a subset of the packages includes a set of relational descriptions, and

b. parsing the stream using the packages establish a structural description and a relational description of the stream.

In a further embodiment based on either of the above embodiments, the grammar further specifies constraints on attribute values, the packages contain information derived from such constraint, and such information is employed in parsing the stream using the packages. Alternatively or in addition, packages in the set are selected to satisfy a desired set of constraints. Also alternatively or in addition, the set of packages includes a first subset of packages for which the depth of the corresponding tree is within a desired first range. Also alternatively or in addition, the set of packages includes a second subset of packages for which the width of the corresponding tree is within a desired second range. Also alternatively or in addition, the set of packages includes a third subset of for which the observed frequency of use in parsing a specific corpus of input streams is within a desired third range. The first subset is optionally identical to the set; the second subset is optionally identical to the set; and the third subset is optionally identical to the set. Also optionally, the grammar is a structure function grammar.

In an embodiment related to the first embodiment described above, each member of a subset of the packages includes a function template that functionally describes syntax associated with the phrase structure tree that the member package represents, and parsing the stream includes evaluating relational content of the stream.

In another embodiment, there is provided a method of parsing a stream of tokens representative of language usage, and the method of this embodiment includes:

providing a set of phrase structure definitions, a set of relational structure definitions, and a set of mappings between them;

using the phrase structure definitions to provide a phrase structure of the stream; and

using the mappings and the relational structure definitions to process the resulting phrase structure to arrive at a functional description of the stream.

Optionally the embodiment further includes using the relational structure definitions to process further the functional description and the stream to arrive at a further enhanced functional description.

In another embodiment, there is provided a method of computing a phrase structure description from a given functional description. The method of this embodiment includes:

providing a set of phrase structure definitions, a set of relational structure definitions, and a set of mappings between them;

using the mappings and the relational structure definitions to process the functional description to arrive at a phrase structure description of the stream.

Optionally, the given functional description results from using the relational structure definitions to parse a stream of tokens.

In yet another embodiment of the invention, there is provided a method of parsing a stream of tokens representative of language usage, and the method of this embodiment includes:

providing a set of phrase structure definitions, a set of relational structure definitions, and a set of mappings between them;

using the relational structure definitions to provide a relational structure of the stream; and

using the mappings and the phrase structure definitions to process the resulting relational structure to arrive at a phrase structure description of the stream.

Optionally in the above parsing methods, the phrase structure definitions, the set of relational structure definitions, and the set of mappings between them are pursuant to a structure function grammar.

In accordance with another embodiment of the invention, there is provided a method of computing a semantic representation of an input stream, and the method includes:

providing a set of semantic interpretation definitions;

parsing the stream in accordance with any of claims 2 and 19 to create a functional description; and

computing the semantic representation from the functional description using the semantic interpretation definitions.

### BRIEF DESCRIPTION OF THE DRAWINGS

The foregoing features of the invention will be more readily understood by reference to the following detailed description, taken with reference to the accompanying drawings, in which:

FIG. 1 is a diagram illustrating structural and relational descriptions of a sentence;

FIG. 2 provides an illustration of the structural and relational objects and their relationship with each other;

FIG. 3 is a diagram of an exemplary phrase structure with functional annotations;

FIG. 4 is a diagram of a function template associated with the phrase structure of FIG. 3 in accordance with an embodiment of the present invention;

FIG. 5 illustrates a grammar specification file in accordance with an embodiment of the present invention;

FIG. 6 is a block diagram of an SFG compiler in accordance with an embodiment of the present invention;

FIG. 7 illustrates a PS tree that can be built utilizing the SFG in FIG. 5, in accordance with an embodiment of the present invention;

FIG. 8 illustrates four template instantiations that are associated with the PS tree of FIG. 7;

FIG. 9 illustrates the format of lexicon specification in accordance with an embodiment of the present invention;

FIG. 10 is a diagram of two-dimensional parsing in accordance with an embodiment of the present invention;

FIG. 11 indicates the process of a structure function grammar based understanding system in accordance with an embodiment of the present invention;

FIG. 12 shows a prior art LFG-based process;

FIG. 13 is a diagram illustrating one type of grammar package in accordance with an embodiment of the present invention;

FIG. 14 provides a first example of how the grammar package in FIG. 13 is used;

FIG. 15 illustrates the features and templates of description output by the parser;

FIG. 16 illustrates the relationship among the coverage of rules, the coverage of packages and linguistic domain;

FIG. 17 illustrates the general architecture of a spoken dialogue system in accordance with an embodiment of the present invention;

FIG. 18 illustrates the architecture of TBSI in accordance with an embodiment of the present invention;

FIG. 19 illustrates the process of natural language understanding in accordance with an embodiment of the present invention;

FIG. 20 illustrates the format of a TBSL specification file;

FIG. 21 is a simplified block diagram of an embodiment of a parser in accordance with the present invention;

FIG. 22 illustrates procedures of semantic evaluation in accordance with an embodiment of the present invention.

FIG. 23 provides examples of semantic evaluation in accordance with an embodiment of the present invention.

### DETAILED DESCRIPTION OF SPECIFIC EMBODIMENTS

As used in this description and the accompanying claims, the following terms shall have the meanings indicated, unless the context otherwise requires:

“Language usage” refers to written or spoken language and therefore includes text and speech.

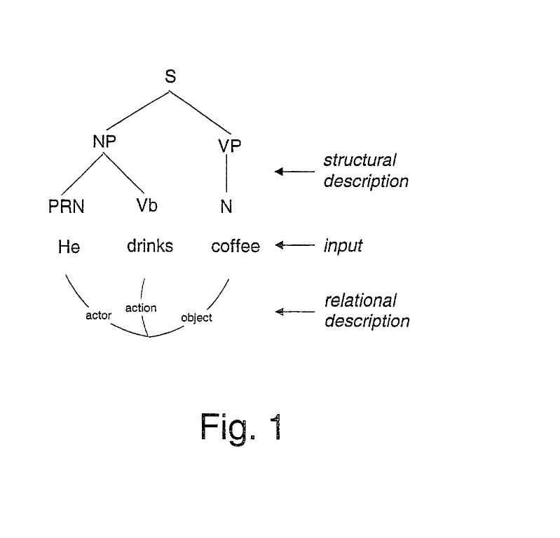

A “parser” is a device that assigns a structural description and/or a relational description to a sentence or phrase. The former expresses the underlying phrase structure. The latter captures links of any nature between words in the input. Examples of these two types of descriptions are shown in FIG. 1.

A “token” is a tangible representation of language usage, and includes a word in normal orthography as well as other forms of representation including, but not limited to, phoneme-encoded and subphoneme-encoded language usage, computer-readable representations of the foregoing, and digitally encoded speech.

A “Structure Function Grammar” (SFG) is a grammar that describes both structural and relational dimensions of syntax.

A “two-dimensional grammar” is a type of grammar that supports structural and relational dimensions in grammar modeling and processing.

A “phrase-structure tree derived from a rule-based grammar” includes a representative part of a tree that is derived from a rule-based grammar in cases where a whole tree is not derived for the package or not used in the package.

A “subset” is a non-null set and need not be a proper subset, so that a “subset” may therefore be (but is not required to be) identical with its associated parent set.

A new grammar formalism, a Structure Function Grammar (SFG), has been developed to:

Describe the grammar of different types of languages

Support knowledge engineering for different parsing strategies: phrase structure parsing, dependency parsing, and their various combinations.

Encourage declarative grammar coding for maximal productivity for grammar writing, debugging and maintenance

It is an engineering grammar in that it is an attempt to find the best compromise between linguistic and engineering requirements:

Adequate descriptive power for wide-coverage of real-life expressions in different languages

Grammar codes independent from a particular processing system but susceptible to lean data structures and modularity in the system architecture

The theories of grammar in computational linguistics—such as Categorical Grammar, Dependency Grammar, Government and Binding Theory, Generalized Phrase Structure Grammar, Head-driven Phrase Structure Grammar, Lexical Functional Grammar (LFG), Tree-Adjoining Grammar—vary in their point of view, motivation, context of development and emphasis. Most of them are mono-dimensional—either they focus on one aspect of grammatical structure and ignore the other, or they sit on one aspect of grammar and derive the rest from it.

We have found that the multilingual and multiple-application context of natural language processing (NLP) puts two important requirements on data modeling and system structure:

A grammar formalism that facilitates maximally economical grammar modeling of various types of languages, such as configurational and non-configurational, inflectional and isolated languages.

A possibility to use one or combined multiple parsing schemes (structural parsing, relational parsing) to fulfill various tasks on a single data model.

These requirements are addressed by a two-dimensional parsing on the basis of a two-dimensional grammar. Like LFG, SFG promotes both structural and relational view of languages. But unlike LFG, SFG pushes the relational view of language further to its logical end to fulfill the second requirement: two-dimensional parsing.

The postulation of two dimensions is based on the conviction that the grammar of languages has two fundamental aspects: structural and relational. Both structural and relational features are valuable inputs to the parsing process and after-parsing process in NLP and neither is derivable completely from the other.

The context free grammar is advantageous in a number of respects. It covers important grammatical properties of natural languages. There is parallelism between the rewrite rule and the tree graph. It is parsimonious and sufficiently flexible for various parser schemes: top-down, bottom-up, mixed mode. Parsing algorithms are well studied. For its structural description, SFG may conveniently utilize the conventional context free grammar formalism.

The context free grammar, however, is deficient for natural language modeling. Several augmentations to the context-free grammar have been proposed in prior art, such as transformation, complex symbols, feature structures. SFG augments the structural description provided by context free grammar with a functional description. The functional description is intended to capture the relational dimension of a grammatical structure. Different languages map structural and functional dimensions differently. This approach is premised on the theory that it is necessary to treat functional description in its own right rather than as appendage to the phrase structure tree. This is a fundamental argument for the functional paradigm of grammar.

Relationship of the Two Dimensions in SFG

SFG is a two-dimensional grammar in the sense that its two dimensions are independent. The descriptive primitives of the two dimensions are defined independently and derived independently. SFG allows relational constructs to be computed not only from structural description but also from other information, such as morphology and semantics independent of structural constructs. It follows LFG in recognizing the necessity to explicitly model both structural and functional structures of language. Moreover, it not only defines the functional constructs independently of structural constructs but also allows for the functional description to be derived independently from structural descriptions. The emphasis on the independence of the two dimensions is motivated and required by flexibility in parsing.

The two dimensions interact with each other in two respects. On the one hand, the relational information licenses the structural configuration. On the other, structural information provides clues about relational distribution through its functional assignments.

The existence of two independent but related dimensions provides two possible perspectives of a grammatical phenomenon. What is awkward to describe on one dimension can be possibly neatly accounted for on the other. The real sense of complementation comes from fully independent (independently defined AND derivable) dimensions. The two-dimensional descriptions can complement each other to increase the overall coverage of the grammar while still keeping the grammar as lean as possible.

The two dimensional description provides different approaches to the description of linguistic facts. This flexibility in data modeling facilitates a comprehensive yet economical approach to grammar modeling.

The two dimensional perspective requires the definition of three basic constructs: (1) structural constructs, (2) relational constructs, and (3) mappings between structural and relational constructs.

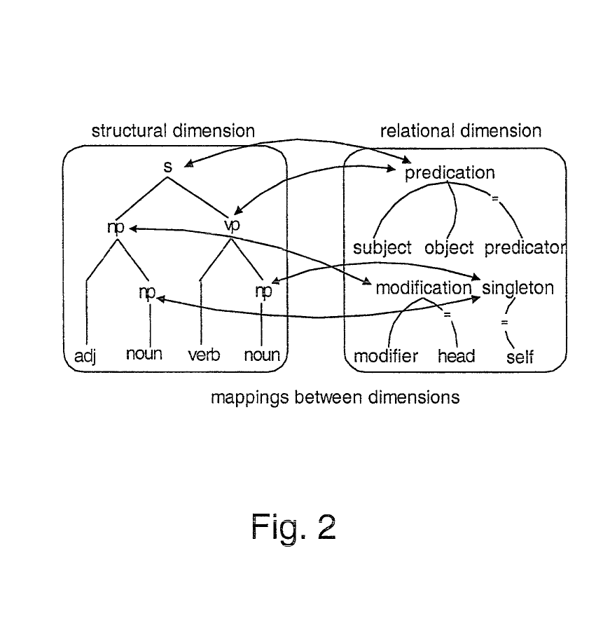

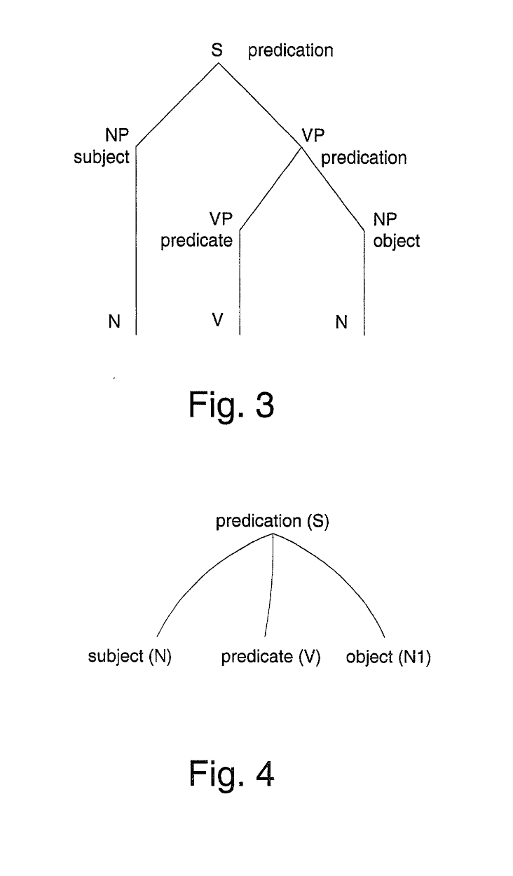

FIG. 2 provides an illustration of the structural and relational objects and their relationship with each other. FIGS. 3 is a diagram of an exemplary phrase structure and FIG. 4 is a diagram of a function template associated with the phrase structure of FIG. 3 in accordance with an embodiment of the present invention.

As illustrated in FIG. 2, on the structural dimension, the following entities must be defined:

Lexical categories, such as noun, adjective, verb,

Constituent categories, such as np, vp, and

Constituent structure, whose components are labeled with lexical and constituent categories, for example, S→NP+VP.

Also as illustrated generally in FIG. 2, on the relational dimension, four entities must be defined:

Attributes, such as gender, number

Values associated with the attributes, such as masculine, feminine

Functions, such as subject, object, and

Function templates, such as predication and modification.

These seven entities are basic objects of SFG. Constituent structures, functions and templates are composed of the other objects in their respective dimensions.

The mappings between structural and relational objects exist in two places

Lexical categories and attribute-value pairs. A lexical category can be associated with a particular set of attributes, even values. For instance, a French pronoun (which is a lexical category) has case, person, gender and number (which are attributes that, for a given pronoun, have corresponding values).

Functional assignment. Function template and functions can be mapped on to constituent structures or their lexical constituents. As is illustrated in FIG. 3, the function template, predication, is assigned to S and VP constituent structures. Subject and objects are mapped onto the nouns and predicate to the verb.

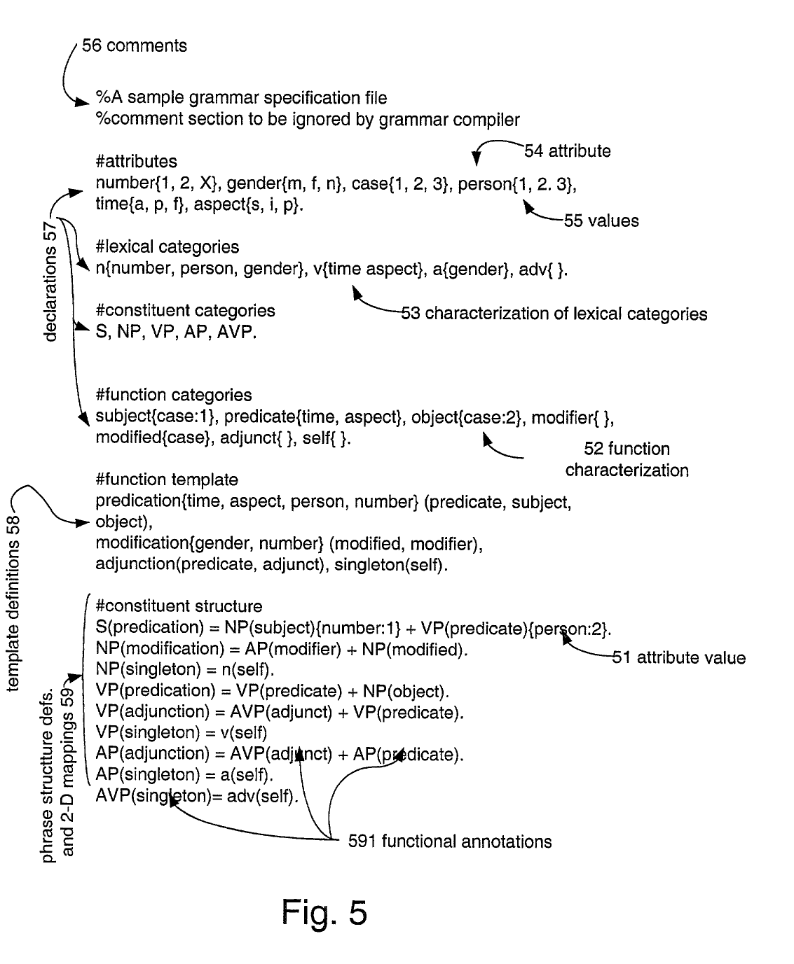

The SFG specification language is designed to enable the linguist to express his SFG model of grammar. This section explains the SFG Specification Language by examples, and in particular the sample SFG grammar specification file shown in FIG. 5.

For the ease of use in grammatical modeling, two issues are identified and considered in the language design.

Size of the specification language

Style of the specification language

It is the objective to keep the specification language as small as possible. The central symbols in the language are ( ), {}, +, and =. They are used to model feature, functional and structural descriptions respectively. The language is designed to have a prose style of grammar modeling rather than that of mathematical formulas. Its symbolic convention makes use of the typography of natural language texts as much as possible, so that grammar modeling is felt more like a composition than a Morse code transcription.

The alphabet used to make up an SFG expression is confined to 26 letters of English, both small and capitalized, 10 figures from 0 to 9. A name is expressed with letters and/or figures. The following are legal and distinctive names:

Link, link, 3link, link4, li3nk, linK

Control symbols include braces, curly brackets, comma, semi-colon, full stop, plus and equation.

Attributes, such as item 54 in FIG. 5, and their values, such as item 55 in FIG. 5, are declared (using a declaration 57 of FIG. 5) as follows.

person{1, 2, 3}, gender{masculine, feminine, neuter}.

It is a list of attributes with their values in the curly brackets. Each attribute is separated with a comma and the list is terminated with a full stop. The name of the attribute must be unique. The name of the value can be shared across attributes.

person{1, 2, 3}, gender{masculine, feminine, neuter}, case{1, 2, 3}.

Every attribute must have at least one value.

The lexical category is defined (using a declaration 57 in FIG. 5) in a fashion (shown as item 53) similar to defining attributes.

noun{number, gender}, verb{time, aspect}, adjective{gender, number}, adverb{}.

The category, noun, has number and gender as its attributes. A lexical category can have no attribute, as in the case of adverb. It is possible to define a special lexical category by insisting that its attribute is instantiated with a particular value, for instance,

noun32{gender:masculine, number}

Specifying Functions

Functions are components of the function templates. The format of their definition is the same as that of the lexical category.

subject{case:1}, predicate{time, aspect}, object{case:2}, adjunct{}.

Specifying Function Templates

The function template is made up of two components:

Template characterization (template definitions 58 in FIG. 5)

Template composition (phrase structure definitions and 2-D mappings 59 in FIG. 5)

Each template has a list of attributes associated with it. It is template characterization, expressed between curly brackets. The template composition specifies what functions it is made up of. It is expressed between braces. Among the composing functions, the first function is treated as head function and the rest are subsidiary functions. In the statement below modified is the head function of modification.

modification{gender, number}(modified, modifier), adjunction(predicate, adjunct).

It is possible to declare a function template without explicitly specifying its characterization as in adjunction. In this case, the attributes of the head function will be treated as characterization of the template. It is possible to impose a particular value of an attribute on a function template.

modification12{gender:masculine, number}(modified, modifier)

In related embodiments, an open list of functions may be specified for a function template as follows.

modification{gender, number}(modified, modifier*)

It means in the template, modification, the function, modifier, can have more than one occurrence.

Specifying Constituent Categories

The constituent categories are declared as follows.

S, NP, VP, AP, AVP.

Specifying Constituent Structure and Mappings to Function Templates

A constituent structure is expressed in the format of a rewrite rules.

NP=AP+NP.

This is not yet a complete statement. For the statement to be complete, mappings to function templates must be added, such as illustrated in FIG. 5.

NP(modification)=AP(modifier)+NP(modified).

This is to say NP has a function template, modification. The composing function of modification, modifier, is assigned to the constituent of NP, AP, and modified to NP. Constraints can be specified on the rewrite rule as follows.

S(predication)=NP(subject){number:1, person:2}VP(predicate){person:2}.

The function template and function are assigned to a phrase structure (PS) constituent through the PS rules and processed during PS construction. For every phrase structure constituent, there is a functional specification: a function and function template associated. The exception is the top and terminal node of the PS structure, which has only template assignment or function assignment.

SFG Specification File

FIG. 5 illustrates a grammar specification file in accordance with an embodiment of the present invention. The file consists of five parts:

attribute specification

function specification

template specification

constituent specification

constituent structure specification

Their order is fixed. The hash sign can be used to signify the title of the section. The percentage sign instructs the compiler to ignore everything until the next line.

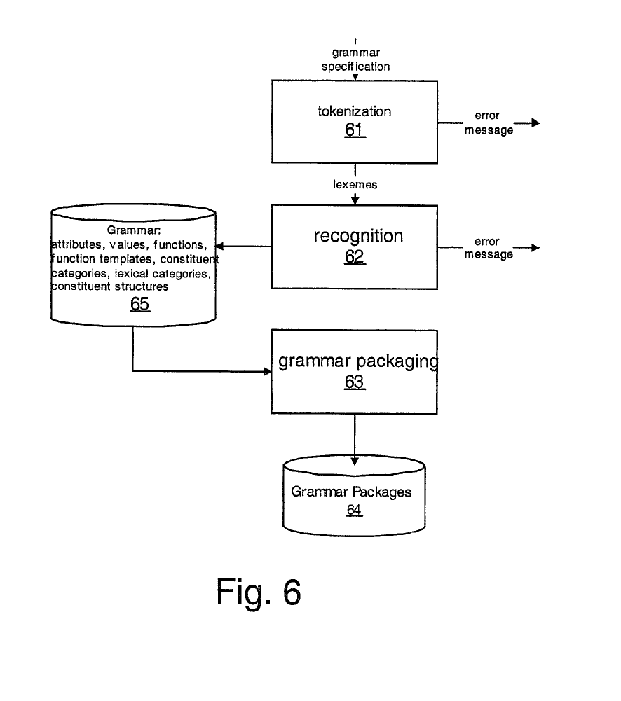

FIG. 6 is a block diagram of a grammar package compiler in accordance with an embodiment of the present invention. The grammar specification (an SFG file) is input to the tokenization process 61 to separate the various lexemes in the SFG file (see for example FIG. 5). The tokenization process checks that the SFG file follows the correct format and produces error messages when the SFG file format is incorrect. The lexemes are then used in the recognition process 62 to create an internal representation of the grammar (65) comprising all attributes, values, functions, function templates, constituent categories, lexical categories and constituent structures. The recognition process will check that the SFG description is valid, for example that constituent structures only use constituent categories that are defined etc. On detection of errors an appropriate error message is generated. The grammar packaging process (63) then builds all possible grammar packages (representing phrase structure trees) that meet the descriptions and constraints described by the grammar and by the optional constraints on packages, such as width and depth of the resulting packages. The grammar packages that meet the constraints are stored in the grammar package database (64) which can be further optimally organized for fast retrieval and access by the parser process that will use the grammar packages.

Genericfunction and Template

They are sugarcoating devices to prevent unnecessary enumeration in the grammar modeling.

Generic function

Generic functions are defined as follows.

. . . ,adjunct{}, self{}, . . .

It implies that the function, adjunct or self, takes as its characterization whatever attribute-values pairs of the constituent playing the role of adjunct or self.

Generic template

A generic template has a generic function as its head. Its characterization is taken from the characterization of the generic function, which in turn is taken from the daughter constituent assuming the function. It is specified as follows.

. . . singleton{self}, . . .

In the case of the following rule,

AP(singleton)=adj(self).

The compiler will build a concrete template for this constituent structure. The concrete template will take all the attributes from adj as its characterization. When a concrete AP constituent structure, the attribute-values pairs of adj will be percolated to the concrete template.

AP(singleton)=adv+AP(self).

The characterization of the concrete template will be percolated from a lexical constituent through the path of head functions.

Mapping Underspecification

The mappings between structural constructs and relational constructs are not neat, otherwise there is no need to distinguish them. There are two possibilities of mapping underspecification.

Mapping underspecification of structure

This occurs when some constituent in the structural construct does not play any role in the template.

AP(singleton)=adv +AP(self).

This is a way to ignore constituents that do not contribute to the computation of the relational constructs.

Mapping underspecizfcation of template

Mapping underspecification of templates, when one or more the composing functions are not assigned to any constituent. For instance,

. . . ,predication{predicator, subject, object}, . . .

S(predication)=NP(subject)+VP(predicator).

VP(predication)=VP(predicator)+NP(object).

It is legal to assign incomplete templates to constituent structures. The existence of merge operations in parsing will be presupposed.

Recursive Feature/Functional Structure

Attributes are primitive entities in SFG. There is no nesting of attributes in an attribute. Different from feature unification grammars such as HPSG and LFG, there is no such a thing as 'path of attributes' or complex feature terms.

The function is a primitive entity in functional description. It cannot be nested. Though the template has a structure, template nesting is not necessary in functional description.

Though they are believed to provide expressive power to the formalism, the use of recursive feature structure with can weigh down the parsing process. The decision between a flat and recursive feature representation is a trade-off between expressiveness of the formalism and complexity of computation. Since SFG is intended as computational grammar for real-time applications, the reduction of computation complexity is the priority in this case.

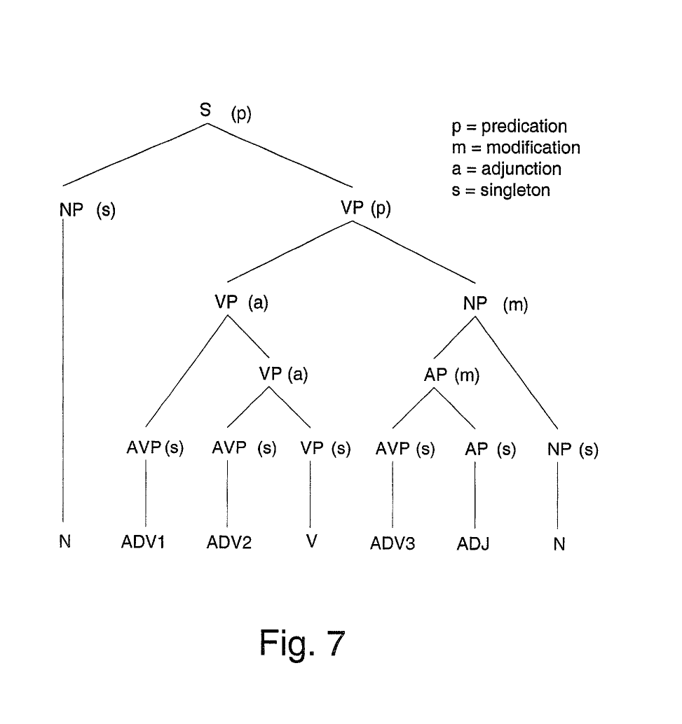

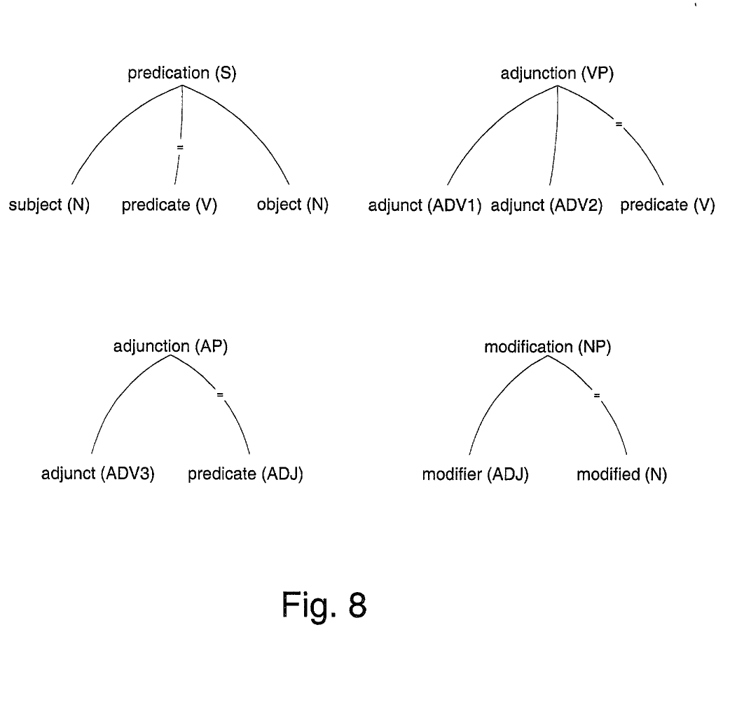

FIG. 7 illustrates a PS tree that can be built utilizing a SFG in accordance with an embodiment of the present invention. The functional description consists of four merged template instantiations, shown in FIG. 8.

Lexicon for SFG

The lexicon provides three kinds of information:

lexical category

lexical characterization

functional context

The lexical category is defined in the grammar specification. The lexical characterization is the form of attribute-values pairs. It is feature description of the lexical entry. It can be morphological, semantic or pragmatic in nature. The minimal requirement of sound lexical characterization is that it must contain the characterization of the lexical category. The functional context specifies the function template in which the lexical entry plays a role. For instance, the transitivity relationship of a verb can be captured by the function templates that require zero or one or two objects. The functional context can be under-specified. In other words, the lexical entry does not have any functional expectations or constraints on the derivation of functional description.

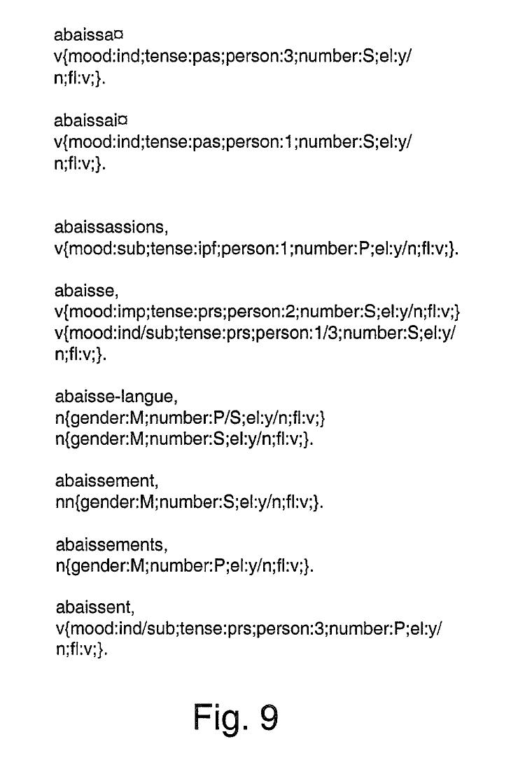

The format of lexicon specification in accordance with an embodiment of the present invention is illustrated in FIG. 9.

2-D Parsing

On the basis of a two-dimensional grammar such as SFG, the parser has two main modules:

structural parsing

functional parsing

The task of these modules is identical: to build structural and functional description, though their approach is different. This is made possible by the independence of the dimensions in the grammar.

The structural parsing is structure-driven. It operates on the PS definitions. It builds the legitimate PS tree. Since PS rules are annotated with grammatical functions and function templates, the functional templates can be derived from the tree. The functional annotation can be also used as a licensing device to control the overgeneration of the PS rule.

The functional parsing is driven by the function template. The process seeks to build function templates with clues from morphological, lexical and semantic features of constituents. Once the functional templates are derived, a PS tree can be built according to the structure the functional templates are mapped to. This structural description is the canonical form.

Different Solutions for Different Languages

Structural parsing is better suited for configurational languages where there is a neater mapping from structural to functional descriptions. Functional parsing or dependency parsing, abstracting away from structural details, is at its best to cope with non-configurational languages, where word order is freer.

The independence of the dimensions allows for different problem-solving approaches. This builds into the parser some flexibility in problem solving. Given a problem, there is a choice of

which mode of parsing is used;

which mode of parsing is used first in a complementary use of 2 dimensions.;

when one mode of parsing is switched to the other.

Different Solutions for Different Tasks

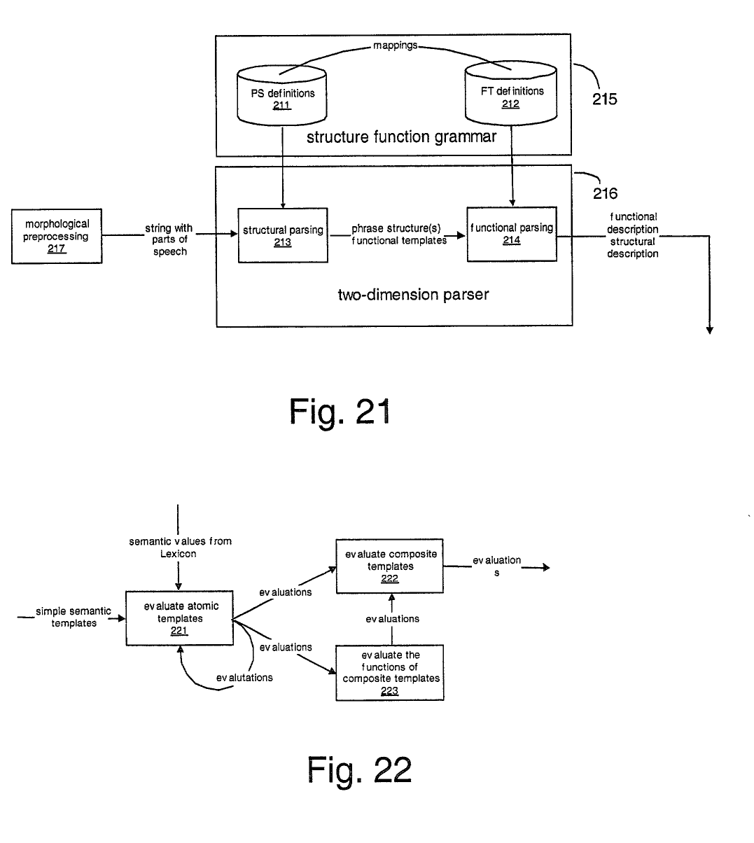

FIG. 21 shows a typical use of two-dimensional parsing. The parser uses 2 related data stores: phrase structure definitions 211 describe the structural relations between tokens in the stream for the language usage; the functional template definitions 212 describe the functional relations between tokens in the stream, mapped to the phrase structure definitions in 211. The input stream of tokens is first preprocessed using morphological pre-processing (217) to derive the corresponding sequence of parts-of-speech and (not shown) attribute values. This stream of parts-of-speech and attribute values is then subject to structural parsing 213, which is informed by phrase structure definitions 211, to arrive at phrase structures and corresponding functional templates which are further parsed by functional parsing 214 to compute the functional and structural descriptions that are the output of the parser.

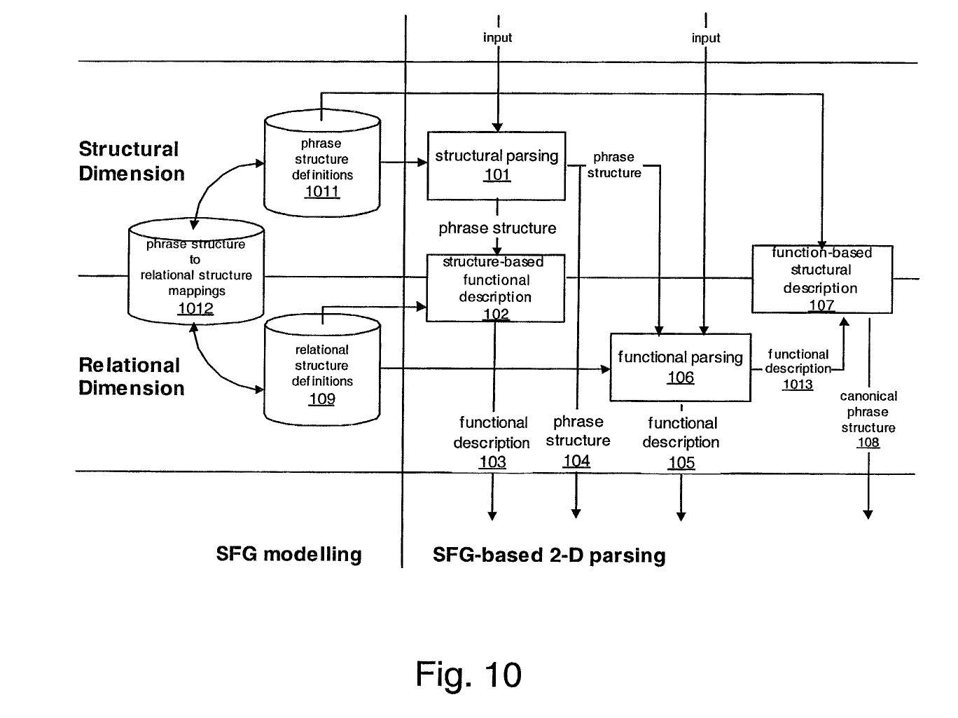

FIG. 10, which expands on the uses shown in FIG. 21, is a diagram of 2D parsing in accordance with an embodiment of the present invention. The two-dimensional parser is composed of several modules. Depending on the nature of the task and language, the solution is channeled through different modules. In particular, FIG. 10 shows various possible uses of two-dimensional parsing. The parser uses three related data stores: phrase structure definitions 1011 describe the structural relations between tokens in the stream for the language usage; the relational structure definitions 109 describe the functional relations between tokens in the stream. The phrase structure to relational structure mappings 1012 relate the two definitions. Together these data stores 109, 1011, and 1012 provide a two-dimensional model of language usage.

A first use is of this two-dimensional model is to subject a token input to structural parsing in process 101, which is informed by phrase structure definitions 1011, to arrive at phrase structure 104. This is effectively a one-dimensional use of the data, where parsing only considers the structural dimension.

A second use is to subject the phrase structure computed by structural parsing in 101 to the structure-based functional description process 102 to compute a functional description by using the relational structure descriptions 109 corresponding to the phrase structure. This is two-dimensional parsing, where the relational description is fully driven by the structural dimension.

A third use is to further parse the resulting phrase structure description from 101 and the input in the functional dimension in functional parsing process 106 using relational structure definitions 109 to build the functional description 105. This functional description is not only driven by the structural dimension, but is computing a more detailed or complete functional description seeded by the initial functional description associated with the phrase structure that is input to 106. This is two-dimensional parsing, with first parsing in the structural dimension and then completing the functional description by further parsing in the functional domain.

A fourth use is to utilize the resulting functional description 1013 from process 106 in the function-based structural description process 107 to compute a canonical phrase structure 108. This approach allows use of the enhanced functional description obtained by parsing in the functional domain to create an enhanced structural description of the input.

A fifth use may result from not parsing the input first in 101 but instead passing it immediately to 106 without a phrase structure. This approach causes parsing to be first done in the relational dimension, to be optionally followed by a structural dimension parse. (Such an approach is not shown in FIG. 10.)

FIG. 10 only shows serial processing. Interleaved processing, where computations in the structural and functional domain are following each other in each step of processing the input stream, is also possible.

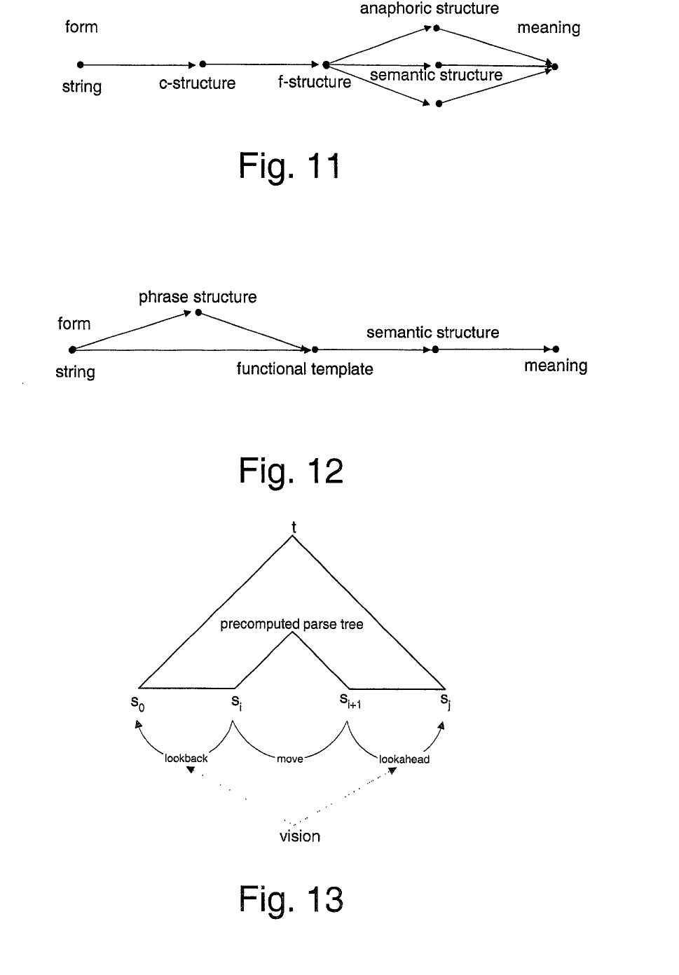

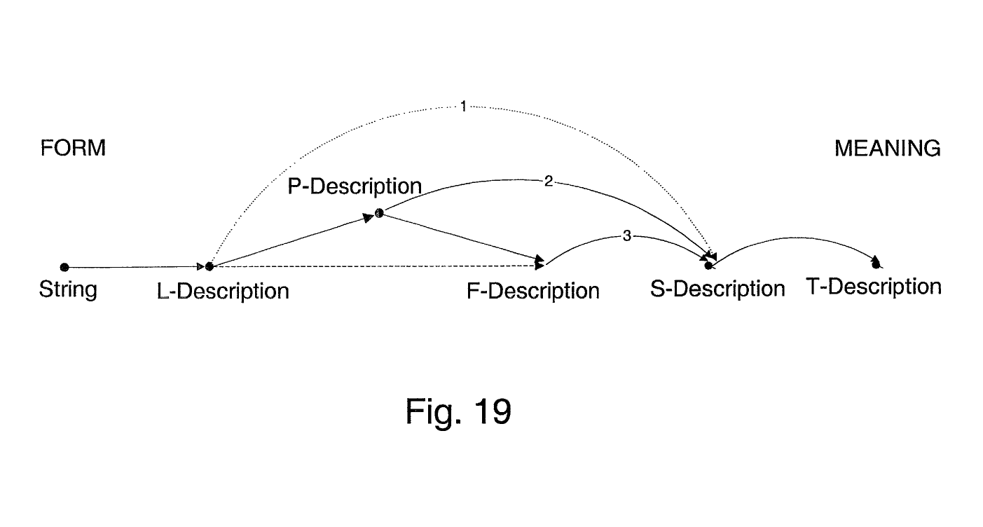

FIG. 11 indicates the process of a structure function grammar based understanding system in accordance with an embodiment of the present invention. Compare FIG. 11 with FIG. 12, which shows a prior art LFG-based process, taken from Kaplan, R. M., The formal architecture of Lexical-Functional Grammar, Journal of Information Science and Engineering, 1989, 5, 305-322. FIG. 19, which provides an embodiment similar to that in FIG. 11, is described in further detail below.

Mode of Operation of the Two-Dimensional Parser

There can be two processing modes of the two-dimensional parser: serial and interleaved. What is presumed above here is a serial processing: in a first phase, the parser uses the structural dimension to build up a structural description, and its related functional description. In particular, a token input is subject to structural parsing in process 101, which is informed by phrase structure definitions 1011, to arrive at phrase structure 104. In a second phase, the resulting phrase structure description and the input are further parsed in the functional dimension in functional parsing process 106 using relational structure definitions 109 to build the final functional description 105. The phrase structure definitions 1011 and the relational structure definitions 1012 are related by mappings between them, shown as phrase structre to relational structure mappings 1012.

An interleaved processing strategy is also a possible. In the interleaved processing, there is no strict sequence of one dimension followed by the other, but the parsing is done in the two dimensions on every intermediate step in the parsing process. A potential advantage of this process mode is to bring functional data to bear on the structural parsing so that the parser can recover extra-grammatical structural variations.

It is further possible to take the functional descriptions derived form either of the above approaches and to apply a function-based structural description process 107 to develop what we call “a canonical phrase structure” 108, which is not necessarily identical to phrase structure 104 but which is associated with it by the common functional description 103 or 1013.

Grammar Packaging

The technique of grammar packaging is designed to enable the parser to operate on a set of related rules rather than on a single rule at a time of parsing operation. If a parse of a sentence is likened to a building, parsing is a process of constructing the building with prefabricated material. The idea of prefabrication divides the construction into two stages: building prefabricated parts and assembling them. The two-stage process promises efficiency in the second stage. In other words, Grammar packaging is a technique of pre-computing (off-line) partial solutions, given rules in SFG.

Given basic definitions of grammar (parts of speech, constituent categories and structures, attributes and values, function templates for SFG), the process of packaging the grammar is to derive complex grammatical entities off-line for the parser to use on-line. The data and sizes of grammar packages vary from one application to another. The technique offers original solutions in grammar engineering and parser developments. Here we address topics including:

Package-driven parsing: such parsers recognize the partial solution instead of constructing them from scratch and assemble them into a whole solution.

Grammar fine-tuning: automatically or manually tuning the coverage of the grammar in terms of packages.

Coding the grammatical behavior in the lexicon.

Augmentation to NLP systems with statistics of packages.

Machine learning of grammar by packages with help of package-driven parsers.

Types

There are two main types:

Packages for structural parsing

Packages for functional parsing

Packages for Structural Parsing

FIG. 13 is a diagram illustrating one type of grammar package in accordance with an embodiment of the present invention.

Packages for structural parsing are based on phrase structure trees. The minimal data requirement in a package is the categories of the root and leaves of the phrase structure. The former is the category of package and the latter are the elements of package.

Depending on the requirement of the application, other useful information can be added.

If feature operations and functional description are required, the package will include function templates, function assignment and feature constraints.

If the partial parses identified by the right packages need to be combined, then packages will include internal nodes of the phrase structure to be able to perform tree grafting or merging operations.

If the contextual constraints should be imposed on the applicability of a package, then lookbacks and lookaheads must be included.

If the packages are used to chunk an input, then the elements of packages must be lexical categories/lexical tokens. (Chunking is a term in NLP, used here to refer to processing an input utterance and indicating the start and end of constituents in the phrase structure, without creating a hierarchical tree of constituents.)

If the packages are used to combine chunks, then the elements of packages will be non-terminal phrase structure categories.

Packages for Functional Parsing

Packages for functional parsing are based on the function templates, since the parsing operation is based on functional constraints. The minimal data in packages must include the identity of the template as the category of the package. The elements of the package will include information on lexical categories. The element that is assigned a function will also include the function type.

Feature constraints can be added to the elements if the applicability of the package needs to be further restricted.

If the canonical phrase structure needs to be derived from template packages, the information on which phrase structures are mapped to must be included.

Size of Packages

The size of grammar packages is the information required for grammar packaging. It determines the shape of the package and the overall coverage of the linguistic domain by the grammar packages.

Measurement of Packages

The grammar package is ‘measured’ along two dimensions: depth and width. The width is the span of the package over an input. If the width of the package of structural parsing is set to 5, the parsing operation will consider 5 tokens in an input.

The depth of a grammar packages is measured by the number of levels of hierarchy in the phrase structure tree corresponding to the package. By setting appropriate values on the depth and width of packages, the grammar engineer can determine the coverage of the parser on the basis of his grammar. These constraints are important tools for grammar engineers to control the parser behavior: focusing the parser operation on a particular part of the problem domain. Efficiency can be achieved if the parser is rightly engineered to cover the central part of the problem domain.

Constraints on Tree Depth and Width, Attribute Values

The depth and width of grammar packages can be set to any positive integer larger than zero. The different combination of the values, such as depth being 10 and width being 4, will produce grammar packages that

Have different shapes

Jointly cover different parts of the linguistic domain.

If the depth is set to 5, then the package may have a maximum of five levels of structure embedding.

The parameters can be neutralized by setting a very large value, such as 100, 1000. Suppose the depth is set 100 and the width to 5. This means the packaging is probably only constrained by the number of words coverable by the grammar package, as the constraint to have packages less than 100 deep will not likely need to be enforced for any package covering 5 words.

Since the coverage of grammar packages is only a subset of grammatical structures derivable from the grammar model, it is important to make sure that the most appropriate subset is covered.

The depth must be high enough to allow for all the interesting partial solutions modeled in a grammar that has many levels of factoring out constituency.

The width must be sufficient to cover all the interesting packages derivable from a fat-structure grammar.

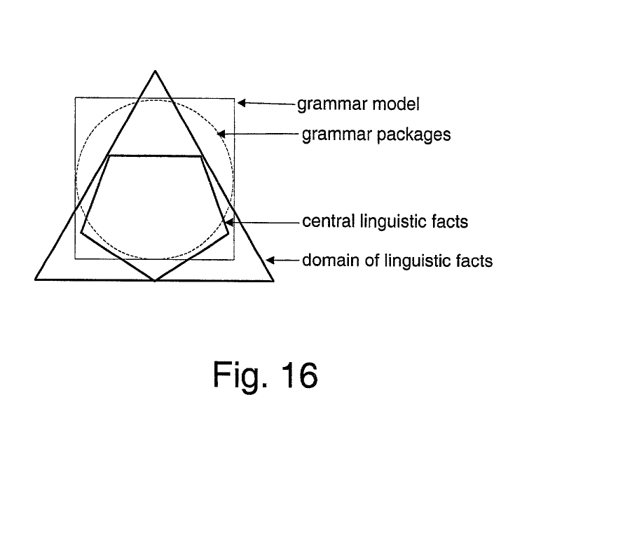

There is a difference between imposing constraints on attribute values and imposing constraints on depth and width of packages. Constraints on attribute values may can be specified in a rule-based grammar from which the packages are derived. Basically such constraints limit when a rule in the rule-based grammar can apply. This property has the effect of reducing the language covered by the grammar model (the square shown in FIG. 16). The effect of attribute value constraints on packages is typically to produce more packages to be used in parsing, because specific combinations of attribute values for a particular tree now need specific packages. There are two ways attribute value constraints may be honored by the parser. One is to create these more specific packages and then for the input stream to check the attribute values and only use the packages that can apply. The other is to neglect the attribute values first, using only packages that reflect no attribute value constraints; then when all possible combinations of packages have been determined in this manner, prune away those packages that fail to fulfill the attribute value constraints. In fact, in a further related embodiment, the parser may operate in a manner that the attribute value constraints are not used as hard constraints, but rather as score indicators; in this embodiment, a parse that makes more attribute value mismatches is scored as worse than one with less, but not unacceptable. (As to this last point, see below: “Scores in terms of certainty of feature description”.)

Creation of Packages

Packages for structural parsing can be created in conventional parsing schemes, top-down or bottom-up, breadth or depth first. Each creation terminates when the resultant phrase structure exceeds the constraint on the size of packages.

Packages for functional parsing is also based on packages for structural parsing. Information on templates and function assignments with respect to the elements of the package is extracted from phrase structure with functional annotations.

Package-Driven Parsers

Main Processes

Recognition of Phrase Structures

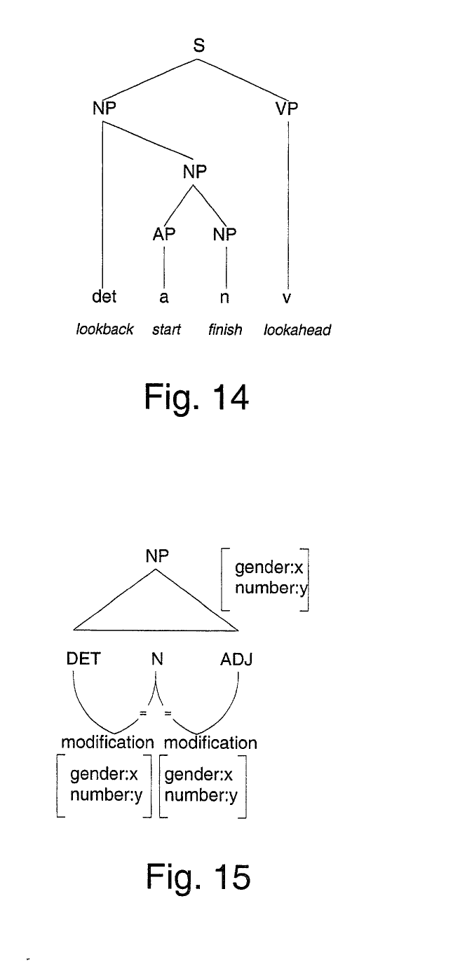

FIG. 14 provides a first example of how the grammar package in FIG. 13 is used.

The on-line operation can be summed up as follows.

Given a string, whose tokens start with Tₒ and ends with Tₙ and a set of grammar packages, G, the parser proceeds from Tₒ to Tₙ or in the other way, seeking for a list of packages from G whose elements cover T_{o,n}. The parse of the string is represented by this list of packages.

Feature Synthesis Operation

The instantiation of an attribute is the assignment of particular values. Given an attribute with two possible values, the possible instantiations of the attribute are four-fold. Take gender{masculine, feminine} for example

gender[+masculine, −feminine]

gender[−masculine, +feminine]

gender[+masculine, +feminine]

Types of attribute instantiations

The attribute instantiation can be grouped into four types

Void instantiation (gender[−masculine, −feminine])

Unique instantiation (gender[+masculine, −feminine])

Multiple instantiation (gender[+masculine, +feminine])

Full instantiation (gender{[+masculine, +feminine])

Two Kinds of Feature Synthesis

The synthesis of attribute instantiations occurs in operations on templates. There are two main types of synthesis of attribute instantiation: synthesis by type and synthesis by token. The former is governed by generic synthesis logic. It is application independent. The latter is based on this logic as well as attribute specific interpretation, which is application dependent.

Type synthesis

The result of type synthesis is conditioned by the types of attribute instantiations. The synthesis logic can be stated as below.

Let void, unique, multiple and full instantiations be α, βχ and δ respectively.

× synthesis operator

[symbol] yields

a=b identical with

if a is equal to b, then the result is a.

if a is not equal to b, then the result is α

aΛb meet of a and b

if the intersection is empty, the result is α

otherwise the result can be instantiation β or χ

| Intersection of | Types of resultant |
|---|---|
| instantiations | Instantiations |
| βˆ χ | α or β |
| χ ˆ χ | β or χ |

I any type of instantiation

α×I [symbol] α

β×β [symbol] β=β

β×χ [symbol] βΛχ

χ×χ [symbol] χΛΛ

δ×I [symbol] I

Token synthesis

The mechanism of token synthesis serves as means to override the generic rules of synthesis stated above. It applies to specific instances of attribute instantiation. The necessity of token synthesis can be seen in the following examples.

Synthesis Operations

Feature synthesis is performed on templates associated with a phrase structure built by the structural parsing. It is a process deriving feature description. FIG. 15 illustrates the feature and template of description output by the parser. There are three main operations:

Instantiate attributes of the functions in the template

Synthesize features of templates (This is a process of bringing attribute instantiations from functions to the template)

Synthesize features of the connected templates. Connected templates are templates whose functions anchor on an identical token.

Each phrase structure has a main template carried by the head constituent. The feature synthesis for a phrase structure must identify templates (directly or indirectly) connected with the main template.

Selection of the best parses

Two basic means of assessing a parse proposed by the recognition process are based on

Coverage of packages

Certainty of functional description

They are effective heuristics to evaluate and select a parse.

Fragments of the Parse

The fewer packages the parse has to cover the input and the more tokens covered by the packages in the parse, the more likely it is a correct result. In short, the parse that has the least fragments is likely to be correct. Since this indicates the agreement of the input with grammar, it is observed as the grammar becomes complete, the heuristic is more effective.

Scores in Terms of Certainty of Feature Description

A feature description can be evaluated in terms of certainty degrees. It is an important clue on how much the phrase structure is endorsed in functional aspects.

Certainty of attribute instantiations

The degree of certainty for an attribute instantiation, certainty for short, is related to the instantiation type. The value of certainty of attribute instantiations is between 1 and 0 inclusive. 1 indicates absolute certainty whereas 0 absolute uncertainty. The value for void instantiation is 0 and that for unique instantiation is 1. The multiple instantiation and full instantiation falls between 0 and 1. Given the number of all possible values for an attribute, n, and the number of the values assigned to the attribute, m, in an instantiation, the certainty, C, is calculated by the following rules:

If m=0, then C=0.

C=[n−(m−1)]/n.

Certainty of feature description

A feature description is a set of attribute instantiations. It is associated with a function, an template or with connected templates in a phrase structure.

The certainty of a feature description, C_{fd}, is the average of the certainty total of the attribute instantiations in the feature description. n is the number of attribute instantiations in the feature description.

$${C}_{fd} = \frac{1}{n} \cdot {\sum }_{i = 1}^{n} {C}_{i}$$

Robustness

Embodiments of package-driven parsers may be made to be robust. Robust parsers driven by grammar packages can perform

Partial parsing. In other words, it outputs a forest of phrase structure trees covering the utterance, not a single tree.

Incomplete parsing. It can skip tokens with which no package can bridge across.

Efficiency

Efficiency is an important potential benefit of embodiments of the present invention employing grammar packaging. In utilizing packages that have been prepared in advance of the parsing process itself, the actual parsing activity has the potential to be more efficient. Efficiency comes from two directions:

The parser's on-line operation is always relevant to the grammar and input concerned. No irrelevant work is performed.

The partial solutions have already been built off-line. The parser does not construct a parse from scratch on-line.

Statistic Augmentation

Statistics of phonemes, morphemes and words have proven to be helpful in speech and morphological processing. But statistics of grammatical rules are not as effective. Grammar packages, be it phrase structures with feature annotations, templates, or combined, are more tangible units of language structure and their distribution is more restricted than abstract rewrite rules, similar to other linguistic tokens. They offer a new dimension of statistics of grammar. N-gram probability of grammar packages, will reveal grammatical tendencies of human languages.

Three advantages of such statistic information are immediately obvious:

Optimized search path: search falling below a threshold of probability is abandoned.

Parse disambiguation. Everything equal, the parse with high probability is preferred.

Assessment of grammatically. High probability adds another dimension parse evaluation, as in ASR hypotheses re-scoring.

The statistics of grammar packages-the frequency with which each package is used-can be obtained through parsing a training corpus. This information can be acquired in the actual operation of the parser and used for self-adaptive performance.

Uses

The parser can be used for various purposes:

Dialogue understanding

Evaluation of recognition hypotheses from speech recognition

Prosodic patterns extraction in text-to-speech generation

Natural language query processing

Question and answer systems

Grammar Engineering Based on Grammar Packages

SFG modeling can produce a grammar that covers a wide range of theoretical possibilities. In real life applications, it is almost impossible to have a grammar that neither over-generates nor under-generates. This is the misfit between the grammar model and the actual linguistic domain, as indicated by the square and triangle in FIG. 16. It has been a serious bottleneck in building rule-based parsing systems to develop a grammar of proper coverage. A typical scenario is that the addition of rules to cover grammatical phenomena most likely has ramification of effects and causes a huge over-generation. As a result, the new grammar also covers a great deal of nonsense. This situation of one step forward and two steps backward is worsened by the complex relationship among rules and difficulty to understand the coverage of the grammar from the rules. Tuning grammar in terms of rules has proven to be work of high complexity and low productivity. This is often cited by advocates of statistical approaches as one of reasons to replace ‘stupid’ humans with ‘intelligent’ machines, which ‘somehow’ do things acceptably. Grammar packages offer effective platform for grammar tuning. The possibility of lexicalization of grammar packages also contributes to the resolution of overgeneration problems.

Tuning Grammar Through Grammar Packages

Tuning grammar in terms of rules has proven to be work of high complexity and low productivity. Grammar packaging does not maintain the original coverage of the grammar model. Given certain dimensional specifications, the process generates packages that cover only a subset of linguistic facts. The packages represent a weaker grammar. It is illustrated by the square and circle in FIG. 16. The ultimate aim is to bring the circle to fit the pentagon as much as possible for maximal efficiency of processing and the best coverage of central grammatical phenomena. It can be achieved in three steps in package-based grammar engineering.

Provide a grammar model that covers all the central facts (the square covering the pentagon)(including, for example, by placing constraints on attributes as discussed above).

Put constraints on properties of grammar packages to reduce the number of packages being generated while also avoiding the elimination of packages that cover the central linguistic facts (the circle covering the pentagon)(for example, by constraints on depth and width discussed above).

Tailor the coverage of grammar packages that have been generated (modifying the circle to fit the pentagon better).

Tailoring the coverage of generated grammar packages-that is, grammar package fine-tuning-offers an effective solution to the frustration of large grammar coding. It is a solution to keep the step forward without slipping back. The grammarians can trim the overgenerated package and control the on-line search space of the parser by removing the over-generated packages (impossible or rare packages). This is tailoring the circle to fit the pentagon as much as possible is illustrated in FIG. 16. It is an effective means to visualize the coverage of the grammar and on-line search space of the parser so that intelligent decisions can replace the ad hoc trial and error attempts. It is a convenient grammar object to manipulate to tailor the grammar coverage to fit the actual linguistic domain. It opens up automatic or semi automatic fine-tuning of grammar. Running the parser through a representative corpus of inputs produces statistics of package usage, and these permit the elimination of packages that are used infrequently in parsing. The threshold for elimination of packages can therefore be set to eliminate unused and infrequent packages.

Lexicalization of Exceptional Grammar Packages

Grammar packages automatically generated from a SFG model populate the lexicon so that lexical tokens can be brought to bear on the applicability of grammar packages. To avoid the redundancy associated with conventional lexicalization of syntactic structures, packages that cannot apply on a lexical token will be recorded with that token. The purpose is to make use of information on word-specific exceptions from lexicon while still benefiting maximally from the generic nature of grammar rules.

Template-Based Semantic Interpretation

The Template-based Semantic Interpreter (TBSI or TSI) is designed to extract semantic information with respect to certain pragmatic information, such as dialogue scenarios.

System Context

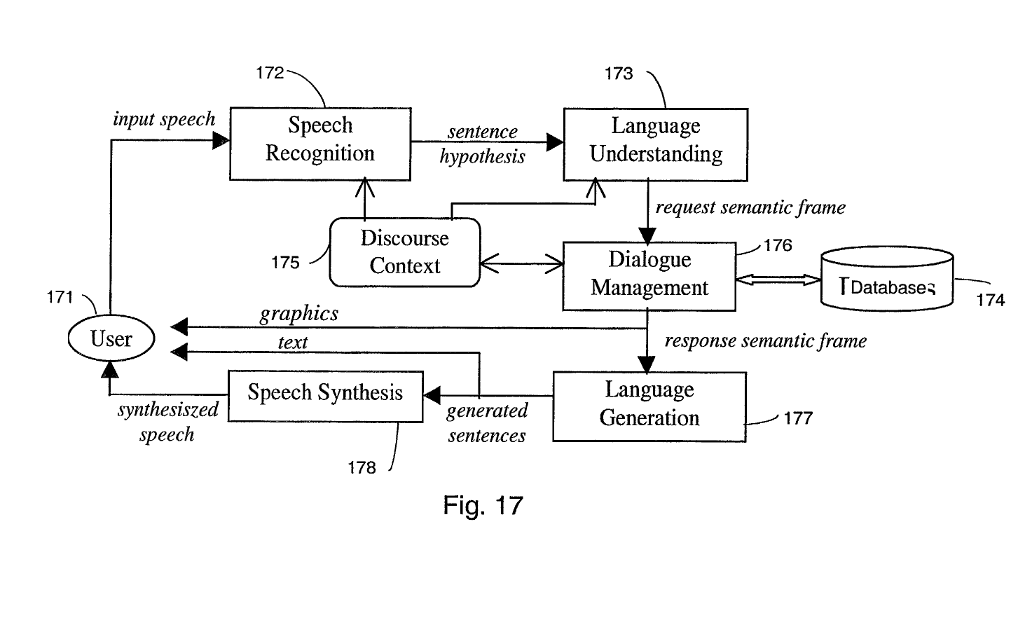

TSI is designed primarily to fit into a spoken dialogue system. FIG. 17 illustrates the general architecture of a spoken dialogue system using a parser in accordance with an embodiment of the present invention. The user 171 utters speech that is processed by a speech recognition system 172 to generate one or more sentence hypotheses, the speech recognition system being driven by discourse context information 175 such as speech recognition grammars for the application. The sentence hypotheses are processed by the Language Understanding process 173 to compute the request semantic frame, using the discourse context information (175), such as the SFG data and semantic interpretation data. The resulting semantic frame describes the semantics of the user's utterance to be used by the dialogue management process 176. The dialog management process may consult a database 174 to obtain information for the user. It then either produces an answer or a new question for the user, by producing a response semantic frame containing the semantic representation of the information or question to be rendered to the user. The dialogue management process also selects or produces discourse context information 175 to reflect the new situation in the dialog. The language generation process (177) produces a natural language sentence that can be either shown as text to the user or can be rendered as spoken language by means of speech synthesis (178).

System Structure

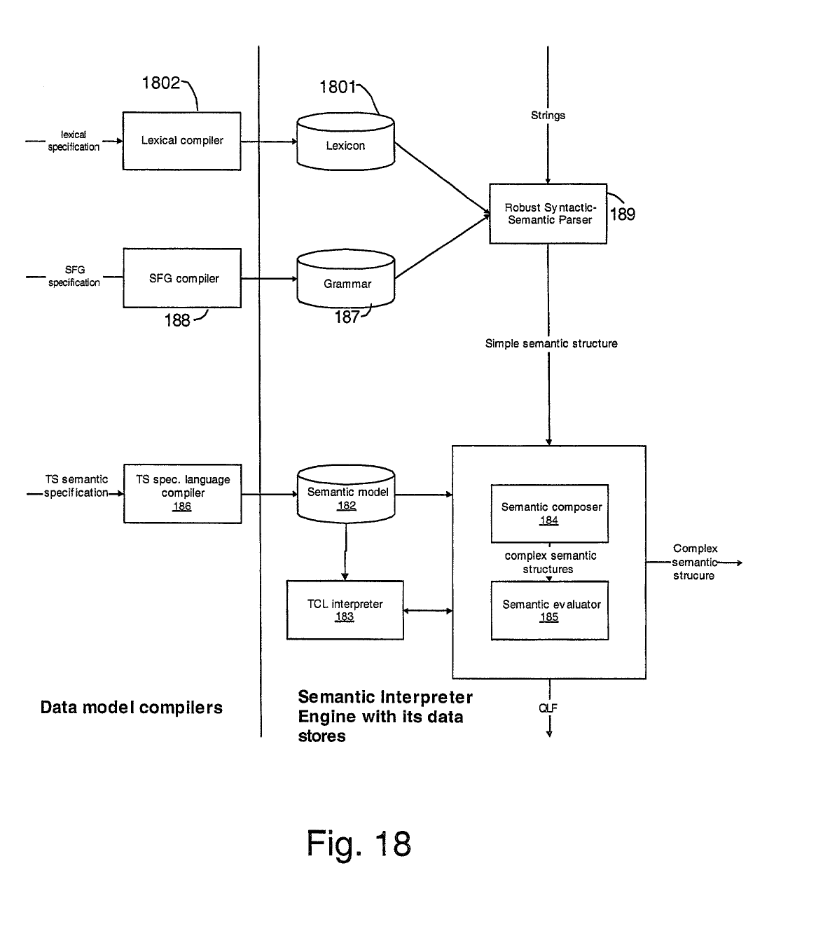

The template-based semantic interpreter (TBSI or TSI) uses the robust parser described above for analyzing a stream of tokens. FIG. 18 illustrates the architecture of a TBSI in accordance with an embodiment of the present invention. The robust parser is shown as item 189, which receives a language usage input tokens shown here as “strings”. The parser 189 has access to lexicon 1801 (obtained via lexical compiler 1802 pursuant to a lexical specification) and grammar 187 (obtained via SFG compiler 188 pursuant to an SFG specification). The simple semantic structure output from the parser 189 is subject to further processing by semantic composer 184 and semantic evaluator 185, which produce a complex semantic structure output and optional QLF (Quasi Logical Form) format, which provides a formal representation of the semantic content of the input. The semantic composer 184 and the semantic evaluator 185 are in communication with the semantic model 182, obtained from a Template-based Semantics Language (TBSL) compiler 186 (which is here and sometimes called “TS specification language compiler”) operating on a Template-based Semantics Language specification file (which is here and sometimes termed “TS semantic specification”) and the TCL interpreter 183 (developed based on semantic model 182). These data objects and processes are discussed in the following sections.

Approach to Natural Language Understanding

Semantic interpretation in a natural language understanding (NLU) system is an issue closely related to the domain of semantics and a particular grammar formalism. There are three notable architectures of the NLU process indicated by the numbered curves in FIG. 19.

String: a sequence of words

L-Description: a list of lexemes, derived from the lexical analysis of String

P-Description: a forest of phrase structure trees

F-Description: a set of instantiated function templates

S-Description: a set of semantic templates, situation-independent, derived from linguistic structures. They are used to express simple semantic constructs, often closely linked with the function templates in F-Description.

T-Description: a set of situation-specific, domain-dependent, task templates. The three curves are three types of semantic interpretation:

Lexeme-based interpretation. It is the least sophisticated and ‘leap’s a longest distance over the process. It is suitable for very simple and restricted task of semantic interpretation

Structure-based interpretation. It is less ‘superficial’ than lexeme-based approach, since the phrase structure provides clues on the relationship among the lexemes. The effectiveness of the approach relies on the requirement that phrase structures can be mapped ‘neatly’ onto its semantic structure or the meaning structure of the application domain.

Function-based interpretation. It is based on ‘deeper’ grammar analysis. It is linguistically more sophisticated and less dependent on special patterns of expression in the sublanguage of the application domain.

The solid line indicates the route TSI ‘travels’ from FORM to MEANING. Our approach is the function-based interpretation. Apart from the interpretation abstracted away from actual structures, it has other merits:

Possibility of decoupling syntax and semantics in processing and modeling

There is a prospect for reusability, since syntactic modeling and processing can have some degree of domain/application independence whereas semantic modeling and processing may be language-independent.

It uses multiple level representation of knowledge and promises a modular approach to knowledge engineering: different formalisms for different tasks and domain facts.

Formalism and Compiler

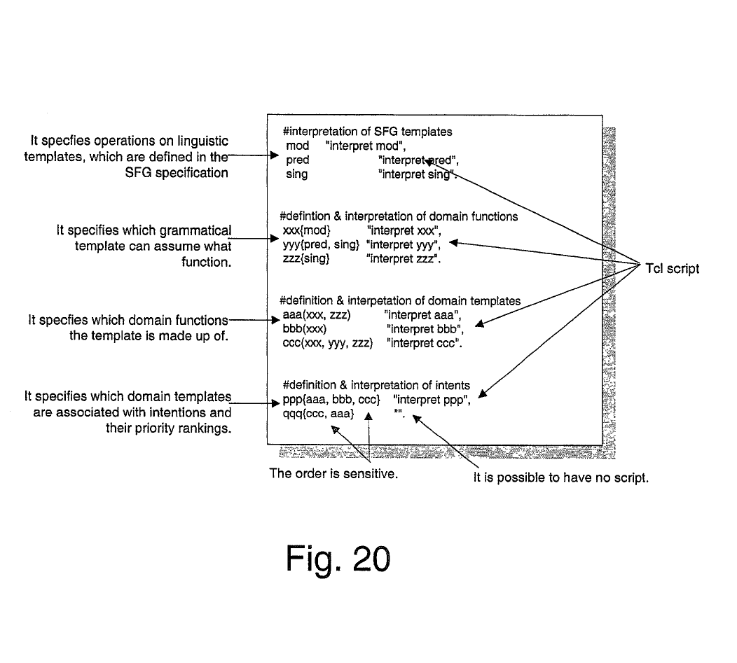

Template-based Semantics Language (TBSL) is the formalism to define semantic structures and its components required for natural language understanding. FIG. 20 illustrates the format of a TBSL specification file. The specification has four sections:

Interpretation of linguistic templates

Definition of domain functions

Definition and interpretation of domain templates

Definition and interpretation of intentions

Grammatical Units

TBSL has three grammatical units:

Term (date, destination, menu1, “tcl_wakeup$1”)

Expression (Atmodification “tcl_Atmodification”,)

Statement (Atquant “tcl_Atquant”, Atempty “tcl_Atempty”.)

A term is made up of 26 English letters (both upper and lower cases) and 10 digits from 0 to 9, except for the special term in between double quotes. The special term can be made up of any characters. The punctuation used is listed in the following table.

| Punctuation | Function |
|---|---|
| Comma | Separating a term or expression. |
| Full stop | Ending a statement |
| Percentage sign | Introducing a comment line, ignored by |
| | the compiler |
| Hash sign | Introducing a section title |
| Curly brackets | Marking an expression of a list |
| Round brackets | Marking an expression of a list |
| Square brackets | Marking an expression of a list |
| Double quotes | Marking a name of evaluation procedure |

Organization of TS Specification File

A TBS model utilizes definitions of conceptual structures in a particular application domain. Given a conceptual space to describe, the task is to partition the space in such a way that

some partitions can be derived from a lexico-syntactic entities (simple concepts);

these partitions can in turn form bigger partitions (complex concepts);

the partitions can be easily manipulated with reference to other communicative factors.

There is no clear-cut demarcation between simple and complex concepts. On the one hand, the semantic model is based on the grammar model: it ‘continues’ from the functional description defined in grammar. On the other, it is related to the dialogue model, for example, the relationship between composite templates with dialogue intentions.

Use of Tcl Scripts

The special term between double quotes indicates the name of the Tcl script to call when the semantic object concerned is evaluated. The body of the script is held in a file, *.tcl. Semantic features are passed from the C program into the Tcl interpretation as global variables of the Tcl interpreter. The process of TBSI consists of two main modules:

Semantic composition

Semantic evaluation

Modeling Semantics of the Application Domain

There are four basic building blocks in modeling the semantics of an application domain in the framework of TBSI

Semantic Primitives: conceptual elements relevant to applications

Simple Concepts: aggregation of semantic primitives corresponding to phrase structures

Complex Concepts: formulating domain semantic templates

Concepts Evaluation: calling TCL scripts to transform concepts into QLF format.

Modeling Simple Concepts in SFG

The relational dimension of SFG is also suitable to describe basic semantic elements. Simple concepts can be described in terms of templates. Semantic primitives can be defined as attributes and values or as template functions. If a concept is expressed by a lexeme or encoded in a phrase structure, it can be treated in SFG.

Following items are defined in SFG.

Syntactic entities (primitive or complex)

Semantic entities (primitive features, simple constructs)

Mappings between syntactic and semantic entities

Modeling Complex Concepts in TBSL

If a concept is typically expressed in more than one phrases or even sentences, it is better to treat in the semantic model in TBSL. For example, the concept of ‘travel’ is a complex concept: it involves the means, date, time, destination, departure, class, etc. The complex concepts typically involve multiple grammatical structures defined in SFG.

The semantic model in TBSL captures two basic information. It specifies the composition of complex concepts, simple concepts that can be its elements, evaluation of the simple and complex concepts and the association of complex concepts with pragmatic objects, such as dialogue intentions.

Modeling Semantic Evaluation

Each semantic object must be evaluated to some other representation or constrained in their legibility in becoming part of a larger object. The evaluation is not part of TBSL but coded in Tcl scripts. The names of the scripts are specified between quotes.

Interpretation Processes

structural parsing with parsers described above to identify semantically interesting phrase structures

derivation of simple concepts, deriving templates from phrase structures

semantic composition: formulating complex concepts

semantic evaluation: calling Tcl scripts to transform complex concepts into other representation

Extraction of Simple Concepts With Package-Driven Parsers

The parser operates on a SFG grammar. It identifies the stream of tokens that have syntactic structures defined in SFG and builds simple concepts from the templates associated with the phrase structures. The structures not covered by SFG are skipped.

Semantic Composition

Given these simple concepts extracted from the input, TBSI seeks to compose them into larger and complex concepts.

The component is given an ordered list of candidates, (possible domain templates). It first short lists the candidates by pragmatic considerations, checking if candidates match the pragmatic settings, such as dialogue intentions active at the juncture of dialogue process.

It then starts the trial composition procedure. It seeks to fill in the slot (domain function) of complex concept in the (domain template) with simple concepts extracted during parsing. It evaluates simple concepts by the associated Tcl script and pass it onto evaluation by the scripts associated with the slot. The purpose is to assess the eligibility of the simple concept becoming part of the complex concept.

The result can be un-instantiated, partially or fully instantiated. The best instantiation is determined according to the following criteria.

Between partially and fully instantiated templates, choose the fully instantiated template.

Between two fully instantiated templates, choose the template of a larger size, the one with more components.

Between two fully instantiated templates of the same size, choose the one with a higher priority ranking (defined in the specification of semantics).

Semantic Evaluation

The process has three features: procedural, compositional and destructive. We address each of these features in turn.

Procedural

FIG. 22, illustrates procedures of semantic evaluation in accordance with an embodiment of the present invention. The semantic evaluation has three stages.

Evaluation of atomic templates

Evaluation of functions of composite templates

Evaluation of composite templates

Each stage feeds on the intermediate evaluation from the previous stage.

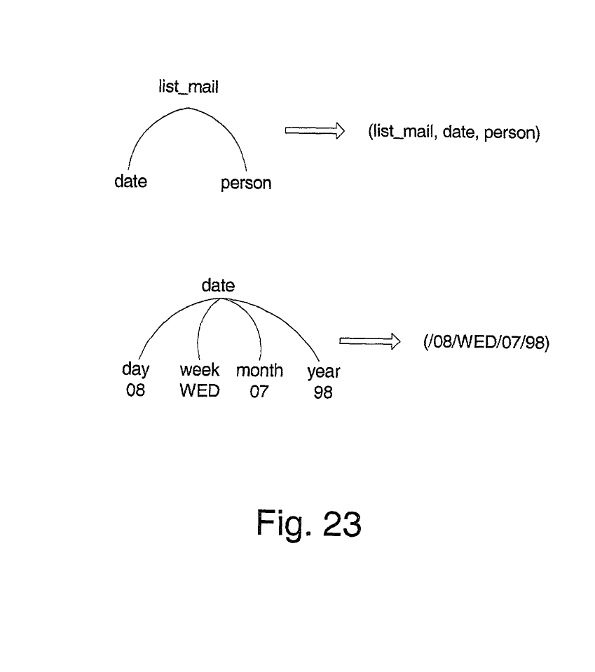

FIG. 23 provides examples of semantic evaluation in accordance with an embodiment of the present invention.

Compositional

The semantic evaluation follows the structures built in the semantic composition.

There are four layers of evaluation. The evaluation of the outer layer is a mathematical function of the evaluations of the inner layers.

The evaluation of atomic templates is also compositional. In many cases, the evaluation of an atomic template requires the evaluation of another atomic template as input, as indicated by the loop in the above figure.

Destructive

The semantic evaluation is destructive in the sense that the result of previous evaluation will be overwritten and lost. This means on-line economy without possibility of backtracking.

Uses of Tcl Procedures

The Tcl procedure for evaluating simple concept ‘synthesizes’ the semantic features of each component. Similarly the Tcl procedure for evaluating composite templates' synthesizes the evaluations of each composing elements.

The Tcl procedure for evaluating the function of a domain template, however, can be used for two purposes. The procedure can be written as treatment common to all the simple concept eligible to fulfil the function. Alternatively, it can be discriminative. Based on the evaluation of the simple concept, it can check if the candidate fulfils the requirement. This use is equivalent to imposing semantic constraint.

The output of the semantic evaluation of valid semantic structures is an expression in another representation (semantic request frame in FIG. 17). It is delivered to the dialogue manager for processing.

What is claimed is:

1. A method of parsing a stream of tokens representative of language usage, the method comprising:
a. Storing a set of packages, each package being representative of a corresponding phrase-structure tree derived from a rule-based grammar; and
b. parsing the stream using the packages to establish a structural description for the stream.

2. A method of parsing a stream of tokens representative of language usage, the method comprising:
a. storing a set of packages, each package being representative of a corresponding phrase structure tree associated with a grammar, wherein a subset of the packages includes a set of relational descriptions, and
b. parsing the stream using the packages establish a structural description and a relational description of the stream.

3. A method according to any of claims 1 and 2, wherein the grammar further specifies constraints on attribute values, the packages contain information derived from such constraint, and such information is employed in parsing the stream using the packages.

4. A method according to any of claims 1 and 2, wherein packages in the set are selected to satisfy a desired set of constraints.

5. A method according to any of claims 1 and 2, wherein the set of packages includes a first subset of packages for which the depth of the corresponding tree is within a desired first range.

6. A method according to claim 3, wherein the set of packages includes a first subset of packages for which the depth of the corresponding tree is within a desired first range.

7. A method according to any of claims 1 and 2, wherein the set of packages includes a second subset of packages for which the width of the corresponding tree is within a desired second range.

8. A method according to claim 5, wherein the set of packages includes a second subset of packages for which the width of the corresponding tree is within a desired second range.

9. A method according to claim 6, wherein the set of packages includes a second subset of packages for which the width of the corresponding tree is within a desired second range.

10. A method according to any of claims 1 and 2, wherein the set of packages includes a third subset of for which the observed frequency of use in parsing a specific corpus of input streams is within a desired third range.

11. A method according to claim 3, wherein the set of packages includes a third subset of for which the observed frequency of use in parsing a specific corpus of input streams is within a desired third range.

12. A method according to claim 6, wherein the set of packages includes a third subset of for which the observed frequency of use in parsing a specific corpus of input streams is within a desired third range.

13. A method according to claim 7, wherein the set of packages includes a third subset of for which the observed frequency of use in parsing a specific corpus of input streams is within a desired third range.

14. A method according to claim 5, wherein the first subset is identical to the set.

15. A method according to claim 7, wherein the second subset is identical to the set.

16. A method according to claim 10, wherein the third subset is identical to the set.

17. A method according to any of claims 1 or 2, wherein the grammar is a structure function grammar.

18. A method according to claim 1, wherein:
each member of a subset of the packages includes a function template that functionally describes syntax associated with the phrase structure tree that the member package represents, and
parsing the stream includes evaluating relational content of the stream.

19. A method of parsing a stream of tokens representative of language usage, the method comprising:
a. providing a set of phrase structure definitions, a set of relational structure definitions, and a set of mappings between them;
b. using the phrase structure definitions to provide a phrase structure of the stream; and
c. using the mappings and the relational structure definitions to process the resulting phrase structure to arrive at a functional description of the stream.

20. A method as in claim 19, the method further comprising:
d. further using the relational structure definitions to process further the functional description and the stream to arrive at a further enhanced functional description.

21. A method of computing a phrase structure description from a given functional description, the method comprising:
a. providing a set of phrase structure definitions, a set of relational structure definitions, and a set of mappings between them;
b. using the mappings and the relational structure definitions to process the functional description to arrive at a phrase structure description of the stream

22. A method according to claim 21, wherein the given functional description results from using the relational structure definitions to parse a stream of tokens.

23. A method of parsing a stream of tokens representative of language usage, the method comprising:
a. providing a set of phrase structure definitions, a set of relational structure definitions, and a set of mappings between them;
b. using the relational structure definitions to provide a relational structure of the stream; and
c. using the mappings and the phrase structure definitions to process the resulting relational structure to arrive at a phrase structure description of the stream.

24. A method according to any of claims 19, 21, and 23, where the phrase structure definitions, the set of relational structure definitions, and the set of mappings between them are pursuant to a structure function grammar.

25. A method of computing a semantic representation of an input stream, method comprising:
a. providing a set of semantic interpretation definitions;
b. parsing the stream in accordance with any of claims 2 and 19 to create a functional description; and
c. computing the semantic representation from the functional description using the semantic interpretation definitions.
